(19) United States
(12) Patent Application Publication
(10) Pub. No.: US 2012/0327347 A1
(43) Pub. Date: Dec. 27, 2012

(54) LIQUID CRYSTAL DISPLAY DEVICES AND METHODS OF MANUFACTURING LIQUID CRYSTAL DISPLAY DEVICES

(76) Inventors: Sung-Ho Cho, Yongin-city (KR); Seung-Jae Lee, Yongin-city (KR); Ji-Su Kim, Yongin-city (KR); Gyung-Soon Park, Yongin-city (KR)

(21) Appl. No.: 13/312,199

(22) Filed: Dec. 6, 2011

(30) Foreign Application Priority Data
Jun. 24, 2011 (KR) 10-2011-0061761

(51) Int. Cl. G02F 1/1339

(52) U.S. Cl. 349/138; 349/155; 349/190

(57) ABSTRACT

A liquid crystal display device may include a first substrate having a display area and a non-display area, a first electrode located on the first substrate at the display area, a second substrate opposed to the first substrate, a second electrode located on the second substrate at the display area, a liquid crystal layer located between the first electrode and the second electrode, a spacer located between the first substrate and the second substrate in the non-display area, a sealant located adjacent to the spacer, and a blocking structure located beneath the spacer.

### CROSS-REFERENCE TO RELATED APPLICATION

This application claims priority under 35 USC §119 to Korean Patent Application No. 2011-0061761 filed on Jun. 24, 2011 in the Korean Intellectual Property Office (KIPO), the contents of which are herein incorporated by reference in their entirety.

### BACKGROUND

1. Field

Example embodiments relate to liquid crystal display devices and methods of manufacturing liquid crystal display devices.

2. Description of Related Art

A liquid crystal display device displays an image using variations of optical characteristics of liquid crystal molecules included therein. The liquid crystal display device usually includes a liquid crystal display panel and a backlight assembly for providing light to the liquid crystal display panel.

The liquid crystal display panel includes an array substrate on which thin film transistors are arranged, a color filter substrate on which color filters are located, and a sealant for providing a cell gap between the array substrate and the color filter substrate, and for sealing the array substrate and the color filter substrate, and a liquid crystal layer for adjusting transmittance of light according to an electric field generated between the two substrates.

Generally, the liquid crystal layer of a conventional liquid crystal device is formed by a liquid crystal injection method or a liquid crystal dropping method. In the liquid crystal injection method, the liquid crystal layer is injected between the two substrates while maintaining a space between the two substrates in a vacuum. As for the liquid crystal dropping method, after applying the sealant on one of the substrates, liquid crystal molecules are dropped and dispersed to form the liquid crystal layer between two substrates by pressing the two substrates.

In the conventional liquid crystal display device, the sealant between the two substrates is usually hardened by irradiation of ultraviolet (UV) ray. However, while forming the liquid crystal layer by the above-mentioned method, defects such as stains may be generated along peripheral portions of the liquid crystal display panel in which the sealant is formed, and the liquid crystal layer may be easily contaminated and deteriorated by the sealant. The defects of the liquid crystal display panel may be generated by various causes such as a radiation time of the UV ray, a processing time of a cleaning process, a processing time of a bonding process, etc. while performing processes for forming the liquid crystal layer, the sealant, the spacer, etc. In manufacturing of the conventional liquid crystal display device, stains may be severely generated along a seal line of the liquid crystal display panel in accordance with reactions between ingredients in the sealant and the liquid crystal layer. Additionally, the liquid crystal layer may be easily and frequently deteriorated because moistures or impurities may easily enter into the liquid crystal layer while using the liquid crystal display device.

### SUMMARY

Example embodiments provide a liquid crystal display device having a blocking structure to prevent defects of a display panel and deterioration of a liquid crystal layer.

Example embodiments provide a method of manufacturing a liquid crystal display device having a blocking structure to prevent defects of a display panel and deterioration of a liquid crystal layer.

According to example embodiments, there is provided a liquid crystal display device including a first substrate, a first electrode, a second substrate, a second electrode, a liquid crystal layer, a spacer, a sealant, and a blocking structure. The first substrate may have a display area and a non-display area. The first electrode may be located on the first substrate at the display area. The second substrate may be opposed to the first substrate. The second electrode may be located on the second substrate at the display area. The liquid crystal layer may be located between the first electrode and the second electrode. The spacer may be located between the first substrate and the second substrate at the non-display area. The sealant may be located adjacent to the spacer. The blocking structure may be located beneath the spacer.

In example embodiments, the liquid crystal display device may further include a protection layer on the first substrate and an insulation layer on the protection layer.

In example embodiments, the blocking structure may include a recess formed on the insulation layer and a blocking member located in the recess.

In example embodiments, the blocking member may be located on a bottom face of the recess, a sidewall of the recess and the insulation layer.

In example embodiments, the spacer may be partially buried in the recess.

In example embodiments, the blocking member may include a material that is substantially the same as that of the first electrode or the second electrode.

In example embodiments, the blocking member may be electrically coupled to the first electrode.

In example embodiments, the blocking member may be configured to generate an electric field around the spacer when a voltage is applied to the blocking member.

In example embodiments, the liquid crystal display device may further include a compensation member located on the spacer.

In example embodiments, the spacer may include a first spacer and a second spacer that are located between the first substrate and the second substrate at the non-display area.

In example embodiments, the sealant may be located between the first spacer and the second spacer.

In example embodiments, the blocking structure may include a first recess, a first blocking member, a second recess, and a second blocking member. The first recess may be formed on the insulation layer under the first spacer. The first blocking member may be located in the first recess. The second recess may be formed on the insulation layer under the second spacer. The second blocking member may be located in the second recess.

In example embodiments, each of the first blocking member and the second blocking member may be electrically coupled to the first electrode.

In example embodiments, the first spacer and the second spacer may be partially buried in the first recess and the second recess, respectively.

In example embodiments, the liquid crystal display device may further include a first compensation member located on the first spacer and a second compensation member located on the second spacer.

In example embodiments, the liquid crystal display device may further include an insulation layer located on the first substrate and a protection layer located on the insulation layer.

In example embodiments, the blocking structure may include a recess and a blocking member. The recess may be formed through the protection layer to partially expose the insulation layer. The blocking member may be located on the insulation layer, a sidewall of the recess and the protection layer.

In example embodiments, the blocking structure may include a first recess, a second recess, a first blocking member and a second blocking member. The first recess and the second recess may be formed through the protection layer to partially expose the insulation layer. The first blocking member may be located in the first recess. The second blocking member may be located in the second recess.

In example embodiments, the spacer may include a first spacer partially buried in the first recess and a second spacer partially buried in the second recess.

According to example embodiments, there is provided a method of manufacturing a liquid crystal display device. In the method, a switching device may be formed at a display area of a first substrate. A blocking structure may be formed at a non-display area of the first substrate. A first electrode may be formed on the first substrate at the display area. A second electrode may be formed on a second substrate opposed to the first substrate. A liquid crystal layer may be formed between the first electrode and the second electrode. A spacer may be formed between the first substrate and the second substrate at the non-display area. A sealant may be formed adjacent to the spacer.

In forming the blocking structure according to example embodiments, an insulation layer may be formed on the first substrate. A recess may be formed on the insulation layer at the non-display area. A blocking member may be formed in the recess.

In example embodiments, a protection layer may be formed on the first substrate to cover the switching device before forming the insulation layer.

In forming the recess according to example embodiments, a contact hole may be formed through the insulation layer at the display area to partially expose the switching device.

In example embodiments, the recess may be formed using a mask having a blocking region, a transparent region and a transflective region.

In forming the blocking member according to example embodiments, a conductive layer may be formed on a bottom face and a sidewall of the recess, on a bottom face and a sidewall of the contact hole and on the insulation layer. The blocking member and the first electrode may be formed by patterning the conductive layer.

In example embodiments, a compensation member corresponding to the spacer may be formed on the second substrate before forming the second electrode.

According to example embodiments, a liquid crystal display device may include at least one blocking structure covering a lower portion of at least one spacer, so that contamination of a liquid crystal layer may be effectively prevented while forming a sealant, and deterioration by penetration of moistures and/or impurities while using the liquid crystal display device may also be effectively prevented. Further, the spacer may be partially received in the blocking structure, so that defects such as stains can be prevented while manufacturing a liquid crystal display device even though height variation of a sealant and/or a spacer may exist.

### BRIEF DESCRIPTION OF THE DRAWINGS

Example embodiments will be more clearly understood from the following detailed description taken in conjunction with the accompanying drawings. FIGS. 1 to 7A-H represent non-limiting, example embodiments as described herein.

FIG. 1 is a cross-sectional view illustrating a liquid crystal display device in accordance with example embodiments.

FIG. 2 is a schematic plan view illustrating a liquid crystal display device in accordance with example embodiments.

FIG. 3 is a cross-sectional view illustrating a liquid crystal display device in accordance with some example embodiments.

FIG. 4 is a cross-sectional view illustrating a liquid crystal display device in accordance with some example embodiments.

FIG. 5 is a schematic plan view illustrating a liquid crystal display device in accordance with some example embodiments.

FIG. 6 is a cross-sectional view illustrating a liquid crystal display device in accordance with some example embodiments.

FIGS. 7A to 7H are cross-sectional views illustrating a method of manufacturing a liquid crystal display device in accordance with example embodiments.

### DETAILED DESCRIPTION OF EMBODIMENTS

Various example embodiments will be described more fully hereinafter with reference to the accompanying drawings, in which some example embodiments are shown. The invention may, however, be embodied in many different forms and should not be construed as being limited to example embodiments set forth herein. Rather, these example embodiments are provided so that this description will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. When an element is referred to as being “directly on,” “directly connected to” or “directly coupled to” another element or layer, there may be no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations), and the spatially relative descriptors used herein may be interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include variations in shapes that may result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

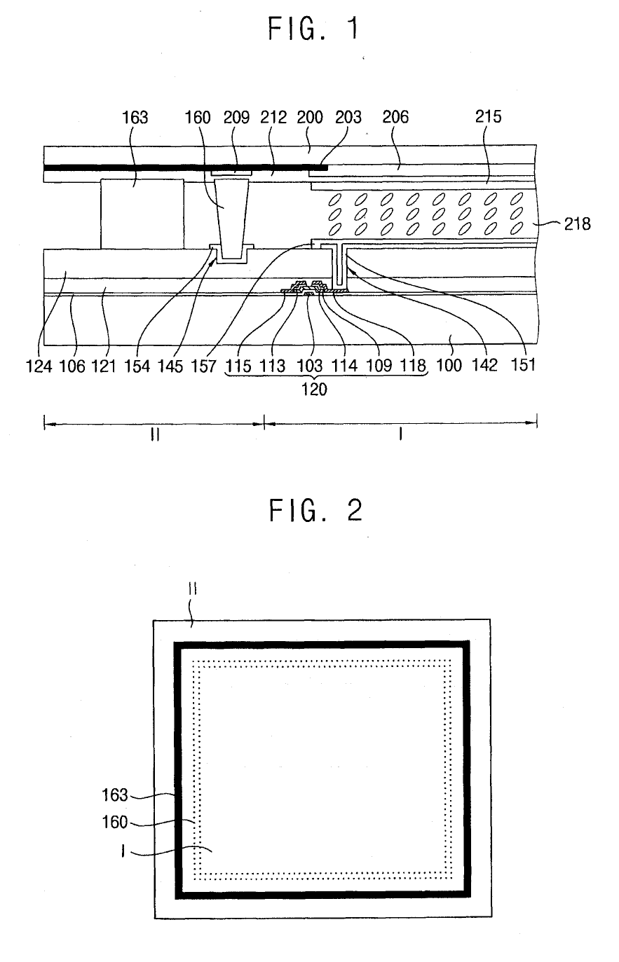

FIG. 1 is a cross-sectional view illustrating a liquid crystal display device in accordance with example embodiments.

Referring to FIG. 1, the liquid crystal display device may include a display area I and a non-display area II. In example embodiments, the liquid crystal display device may include a first substrate 100, a switching device 120, a protection layer 121, an insulation layer 124, a first electrode 151, a blocking structure, a spacer 160, a sealant 163, a liquid crystal layer 218, a second substrate 200, a light blocking layer 203, a color filter 206, a compensation member 209, a second electrode 212, etc.

The first substrate 100 may include a transparent insulation substrate. For example, the first substrate 100 may include a glass' substrate, a quartz substrate, a transparent plastic substrate, a transparent metal oxide substrate, etc. When the liquid crystal display device includes the display area I and the non-display area II, each of the first and the second substrates 100 and 200 may include the display area I and the non-display area II.

The switching device 120 may be positioned in the display area I of the first substrate 100. In example embodiments, the switching device 120 may include a thin film transistor (TFT). In this case, the switching device 120 may include a gate electrode 103, a gate insulation layer 106, an active layer 109, a first ohmic contact pattern 113, a second ohmic contact pattern 114, a source electrode 115, a drain electrode 118, etc. In some example embodiments, the switching device 120 may include an oxide semiconductor device having an active layer containing a semiconductor oxide.

The gate electrode 103 may be positioned in the display area I of the first substrate 100. The gate electrode 103 may include metal, alloy, metal nitride, etc. For example, the gate electrode 103 may include aluminum (Al), an alloy containing aluminum, aluminum nitride (AlNx), silver (Ag), an alloy containing silver, tungsten (W), tungsten nitride (WNx), copper (Cu), an alloy containing copper, chrome (Cr), molybdenum (Mo), an alloy containing molybdenum, titanium (Ti), titanium nitride (TiNx), tantalum nitride (TaNx), etc. These may be used alone or in a combination thereof. The gate electrode 103 may have a single layer structure or a multi layer structure including a metal film, an alloy film and/or a metal nitride film. In example embodiments, a gate line (not illustrated) coupled to the gate electrode 103 may be located on the first substrate 100 and a driving signal may be applied to the gate electrode 103 through the gate line.

The gate insulation layer 106 may be located on the first substrate 100 to cover the gate electrode 103. The gate insulation layer 106 may extend from the display area I of the first substrate 100 to the non-display are II of the first substrate 100. The gate insulation layer 106 may have a uniform thickness on the first substrate 100 along a profile of the gate electrode 103. In some example embodiments, the gate insulation layer 106 may have a relatively large thickness to sufficiently cover the gate electrode 103. In this case, the gate insulation layer 106 may have a substantially level upper face. The gate insulation layer 106 may include oxide, nitride, oxynitride, an organic insulating material, etc. For example, the gate insulation layer 106 may include silicon oxide (SiOx), silicon nitride (SiNx), benzocyclobutene (BCB) based resin, acryl-based resin, etc. These may be used alone or in a combination thereof.

Referring now to FIG. 1, the active layer 109 may be located on a portion of the gate insulation layer 106 under which the gate electrode 103 is located. The active layer 109 may have a size substantially larger than that of the gate electrode 103. In example embodiments, the gate insulation layer 106 may have a stepped portion caused by the gate electrode 103. Thus, the active layer 109 also may have a stepped portion having a construction substantially the same as or substantially similar to that of the gate insulation layer 106. Here, a protruding portion of the active layer 109 may have a width substantially larger than that of the gate insulation layer 106. The active layer 109 may include silicon. For example, the active layer 109 may include amorphous silicon, amorphous silicon containing impurities, polysilicon, polysilicon containing impurities, etc.

The first ohmic contact pattern 113 and the second ohmic contact pattern 114 may be spaced apart from each other on the active layer 109 (e.g., spaced apart by a predetermined distance). Each of the first and the second ohmic contact patterns 113 and 114 may have a size substantially smaller than that of the active layer 109. When the first and the second ohmic contact patterns 113 and 114 are provided, the active layer 109 may be partially exposed. Each of the first and the second ohmic contact patterns 113 and 114 may include silicon, metal oxide, etc. For example, each of the first and the second ohmic contact patterns 113 and 114 may include amorphous silicon, amorphous silicon containing impurities, polysilicon, polysilicon containing impurities, zinc oxide (ZnOx), tin oxide (SnOx), indium oxide (InOx), gallium oxide (GaOx), etc. These may be added alone or in a combination thereof. In example embodiments, each of the first and the second ohmic contact patterns 113 and 114 may also have a stepped portion caused by the gate electrode 103.

The source electrode 115 may be located on the first ohmic contact pattern 113 and the drain electrode 118 may be located on the second ohmic contact pattern 114. Each of the source and the drain electrodes 115 and 118 may include metal, alloy, metal nitride, etc. For example, each of the source and the drain electrodes 115 and 118 may include aluminum, silver, chrome, copper, molybdenum, titanium, tantalum, tungsten, an alloy of these metals, a nitride of these metals, etc. These may be used alone or in a combination thereof. Each of the source and the drain electrodes 115 and 118 may have a single layer structure or a multi layer structure including the metal, the alloy and/or the metal nitride.

The source electrode 115 and the drain electrode 118 may be separated from each other (e.g., separated by a predetermined distance). The source electrode 115 may extend from a first portion of the gate insulation layer 106 to cover the first ohmic contact pattern 113. The drain electrode 118 may extend on the gate insulation layer 106 from a second portion of the gate insulation layer 106 to cover the second ohmic contact pattern 114. Thus, the source and the drain electrodes 115 and 118 may have sizes substantially larger than those of the first and the second ohmic contact patterns 113 and 114, respectively. In example embodiments, a data line (not illustrated) electrically coupled to the source electrode 115 may be located on the gate insulation layer 106 and the data line may apply a data signal to the source electrode 115. Here, the data line may extend on the gate insulation layer 106 in a direction substantially perpendicular to a direction in which the gate line extends.

The protection layer 121 may be located on the gate insulation layer 106 to cover the switching device 120. The protection layer 121 may extend from the display area Ito the non-display area II. The protection layer 121 may have a sufficient thickness to completely cover the switching device 120. In example embodiments, the protection layer 121 may include oxide, nitride, oxynitride, etc. For example, the protection layer 121 may include silicon oxide, silicon nitride, silicon oxynitride, etc. These may be used alone or in a combination thereof. The protection layer 121 may have a substantially level upper face obtained by a planarization process. For example, an upper portion of the protection layer 121 may be planarized by a chemical mechanical polishing (CMP) process, an etch-back process, etc. In some example embodiments, the protection layer 121 may include a material having self-planarizing property. For example, the protection layer 121 may include acryl-based resin, polyamide-based resin, siloxane-based resin, etc. These may be used alone or in a combination thereof. In some example embodiments, the protection layer 121 may have a single layer structure or a multi layer structure including an inorganic material and/or an organic material.

The insulation layer 124 may be located on the protection layer 121 and may extend from the display area I of the first substrate 100 to the non-display area II of the first substrate 100. In example embodiments, the insulation layer 124 may include an organic insulating material. For example, the insulation layer 124 may include benzocyclobutene-based resin, olefin-based resin, polyamide-based resin, acryl-based resin, polyvinyl-based resin, etc. These may be used alone or in a combination thereof. The insulation layer 124 may have a single layer structure or a multi layer structure including the organic insulating material.

In example embodiments, the insulation layer 124 may have a sufficient thickness for forming the blocking structure. Further, the insulation layer 124 may prevent a coupling phenomenon amongst wirings of the liquid crystal display device, thereby enhancing an aperture ratio of the liquid crystal display device.

As illustrated in FIG. 1, the first electrode 151 may be located on the gate insulation layer 124 located in the display area I. The first electrode 151 may be electrically coupled to the drain electrode 118. The first electrode 151 may serve as a pixel electrode of each pixel in the liquid crystal display device. In example embodiments, a contact hole 142 may be formed through the insulation layer 124 and the protection layer 121 to partially expose the drain electrode 118. In this case, the first electrode 151 may be located on the exposed drain electrode 118 and a sidewall of the contact hole 142, and may also extend on the insulation layer 124. In some example embodiments, a contact structure (not illustrated) contacting the drain electrode 118 may be provided in the contact hole 142 of the insulation layer 124 and the protection layer 121. Here, the first electrode 151 may be electrically coupled to the drain electrode 118 through the contact structure.

The first electrode 151 may include a transparent conductive material. For example, the first electrode 151 may include indium tin oxide (ITO), tin oxide (SnOx), indium oxide (InOx), gallium oxide (GaOx), indium zinc oxide (IZO), titanium oxide (TiOx), etc. These may be used alone or in a combination thereof. In some example embodiments, the first electrode 151 may include a reflective material. For example, the first electrode 151 may include aluminum, silver, platinum (Pt), chrome, molybdenum, tantalum, niobium (Nb), zinc (Zn), magnesium (Mg), an alloy of these metals, etc. These may be used alone or in a combination thereof. However, the material included in the first electrode 151 may vary according to an emission type of the liquid crystal display device. For example, when the liquid crystal display device is a top emission type, the first electrode 151 may include a transparent conductive material. When the liquid crystal display device is a bottom emission type, the first electrode 151 may include a reflective material. The first electrode 151 may have a multi layer structure including the transparent conductive material and/or the reflective material.

The second substrate 200 may be substantially opposite to the first substrate 100. The second substrate 200 may be spaced apart from the first substrate 100 (e.g., spaced apart by a predetermined cell gap). In this case, the spacer 160 may substantially secure the cell gap between the first and the second substrates 100 and 200. The second substrate 200 may include a transparent insulation substrate. For example, the second substrate 200 may include a glass substrate, a quartz substrate, a transparent metal oxide substrate, a transparent plastic substrate, etc. In example embodiments, the second substrate 200 may include a material that is substantially the same as that of the first substrate 100. Alternatively, the first substrate 100 may include a material different from that of the second substrate 200.

The liquid crystal layer 218 including liquid crystal molecules may be located between the first substrate 100 and the second substrate 200 in the display area I of the liquid crystal display device. For example, the liquid crystal layer 218 may be positioned in a space primarily provided by the spacer 160 between the first and the second substrates 100 and 200. The liquid crystal layer 218 may adjust a transmittance of light generated from a light source such as a backlight (not illustrated) according to an electric field generated between the first and the second electrodes 151 and 212.

The light blocking layer 203 may be located on the second substrate 200. The light blocking layer 203 may extend from the non-display area II of the second substrate 200 over the switching device 120 located in the display area I. The light blocking layer 203 may include metal, metal oxide, metal nitride, etc. For example, the light blocking layer 203 may include chrome, chrome oxide (CrOx), aluminum nitride (AlNx), cadmium (Cd), nickel (Ni), nickel oxide (NiOx), cobalt (Co), cobalt oxide (CoOx), manganese (Mn), manganese oxide (MnOx), etc. These may be used alone or in a combination thereof. In example embodiments, the light blocking layer 203 may have a single layer structure or a multi layer structure having the metal, the metal oxide and/or the metal nitride.

The color filter 206 may be located in the display area I of the second substrate 200. For example, the color filter 206 may be positioned substantially opposed to the first electrode 151 in the display area I. In example embodiments, a plurality of color filters 206 may be located between the first substrate 100 and the second substrate 200. The color filters 206 may filter light passing through the liquid crystal layer 218 to colors of light. For example, the color filters 206 may include a red color filter for generating red color of light, a green color filter for generating green color of light, a blue color filter for generating blue color of light, etc. Here, the light blocking layer 203 may block light leaked from the color filters 206, thereby enhancing a contrast ratio of the liquid crystal display device.

In example embodiments, the color filters 206 may partially cover the light blocking layer 203. For example, a first portion of the color filter 206 may cover an end portion of the light blocking layer 203 extending to the display area I of the second substrate 200. In some example embodiments, the light blocking layer 203 may not be substantially overlapped with the color filter 206. For example, an end portion of the light blocking layer 203 may make contact with an end portion of the color filter 206. Alternatively, the end portion of the light blocking layer 203 may be spaced apart from the end portion of the color filter 206.

In the liquid crystal display device illustrated in FIG. 1, the compensation member 209 may be located on the light blocking layer 203 in the non-display area II. The compensation member 209 may be adjacent to the display area I, and the spacer 160 may be positioned beneath the compensation member 209. The compensation member 209 may support the spacer 160 with the second electrode 212 interposed therebetween. Further, the compensation member 209 may secure the cell gap of the liquid crystal display device in conjunction with the spacer 160. In example embodiments, the compensation member 209 may include a material substantially the same as or substantially similar to that of the color filter 206 or the light blocking layer 203. In some example embodiments, the compensation member 209 may include a material substantially the same as or substantially similar to that of the spacer 160.

The second electrode 212 may extend from the display area Ito the non-display area II. The second electrode 212 may cover the light blocking layer 203, the color filter 206, the compensation member 209, etc. The second electrode 212 may serve as a common electrode shared with a plurality of pixels of the liquid crystal display device. The second electrode 212 may include a transparent conductive material. For example, the second electrode 212 may include indium tin oxide, tin oxide, indium oxide, gallium oxide, indium zinc oxide, titanium oxide, etc. These may be used alone or in a combination thereof. In some example embodiments, the second electrode 212 may include a reflective material. For example, the second electrode 212 may include aluminum, silver, chrome, molybdenum, titanium, tantalum, niobium, zinc, magnesium, an alloy of these metals, etc. These may be used alone or in a combination thereof. Similar to the above-described the first electrode 151, the second electrode 212 may include the reflective material or the transparent conductive material according to the emission type (e.g., top emission type or bottom emission type) of the liquid crystal display device.

In the display area I of the liquid crystal display device, a first alignment layer 157 may be positioned on the first electrode 151 and a second alignment layer 215 may be located beneath the second electrode 212. The liquid crystal layer 218 may be located between the first and the second alignment layers 157 and 215. The first electrode 151 and the first alignment layer 157 may be substantially opposed to the second electrode 212 and the second alignment layer 215, respectively. In some example embodiments, the liquid crystal display device may include one of the first alignment layer 157 or the second alignment layer 215. For example, only the first alignment layer 157 may be located on the insulation layer 124 to cover the first electrode 115. Alternatively, only the second alignment layer 215 may be located on the second electrode 212. In some example embodiments, the liquid crystal display device may not include the first and the second alignment layers 157 and 215 according to processes for forming the liquid crystal layer 218 and characteristics of liquid crystal molecules in the liquid crystal layer 218.

As illustrated in FIG. 1, the blocking structure may be located on the insulation layer 124 between the display area I and the non-display area II. The blocking structure may include a trench, a groove, a dent or a recess 145 (hereinafter, referred to as “recess”) formed on the insulation layer 124, and a blocking member 154 disposed in the recess 145. The recess 145 of the blocking structure may be positioned on the insulation layer 124 adjacent to the display area I. The recess 145 may be obtained by partially removing the insulation layer 124. For example, the recess 145 may have various cross sectional shapes such as a substantially tetragonal shape, a substantially trapezoidal shape, a substantially rounded shape, etc. Further, the recess 145 may have various planar structures provided along peripheral portions of the insulation layer 124. For example, the recess 145 may have planar structures such as a substantially tetragonal ring shape, a substantially circular ring shape, a substantially elliptical ring shape, a substantially polygonal ring shape, etc. The recess 145 may have a width that is substantially larger than that of a lower portion of the spacer 160.

In example embodiments, the blocking member 154 may be positioned on a bottom face and a sidewall of the recess 145. Thus, the blocking member 154 may have a structure substantially the same as or substantially similar to that of the recess 145. In this case, both of end portions of the blocking member 154 may extend on the insulation layer 124 in the non-display area II. The blocking member 154 may include a transparent conductive material, a reflective material, etc. For example, the blocking member 154 may include indium tin oxide, tin oxide, indium oxide, gallium oxide, indium zinc oxide, titanium oxide, aluminum, silver, chrome, molybdenum, titanium, tantalum, niobium, zinc, magnesium, an alloy of these metals, etc. These may be used alone or in a combination thereof. In example embodiments, the blocking member 154 may include a material substantially the same as or substantially similar to that of the first electrode 151 and/or that of the second electrode 212.

The blocking member 154 may be electrically coupled to the gate line, the data line and/or the first electrode 151. For example, the blocking member 154 may electrically contact the gate line or may make electrical contact with the data line. In some example embodiments, the blocking member 154 may extend to the display area I to make contact with the first electrode 151. Thus, when a voltage is applied to the blocking member 154, an electric field caused by the blocking member 154 may be generated around the spacer 160 located between the blocking member 154 and the second electrode 212 in the non-display area II. Moistures and/or ionic impurities from outside may be trapped in the non-display area II by the electric field generated around the spacer 160, so that diffusion of the moistures and/or ionic impurities toward the display area I having the liquid crystal layer 218 may be effectively prevented. Therefore, deterioration of the liquid crystal layer 218 caused by moistures and/or impurities may be prevented while using the liquid crystal display device.

The lower portion of the spacer 160 for ensuring the cell gap of the liquid crystal display device may be buried in the recess 145 with the blocking member 154 interposed therebetween. For example, the blocking member 154 may be positioned between the lower portion of the spacer 160 and the bottom face of the recess 145 and between the lower portion of the spacer 160 and the sidewall of the recess 145. Thus, a bottom face and a lower side wall of the spacer 160 may make contact with the blocking member 154. When the spacer 160 is partially buried in the recess 154 of the blocking structure, the cell gap of the liquid crystal display device may be properly secured even though a size of the sealant 163 for combining the first and the second substrates 100 and 200 may not be uniform. Further, the blocking member 154 may have a structure enclosing the lower portion of the spacer 160, so that the blocking structure may effectively protect the liquid crystal layer 218 from being contaminated while forming the sealant 163, and also prevent the liquid crystal layer 218 from being deteriorated by moistures or impurities while using the liquid crystal display device. Additionally, the spacer 160 may be partially received in the recess 145 of the blocking structure, such that the liquid crystal layer 218 may be more efficiently prevented from being contaminated by the sealant 163, moistures and/or impurities even if height variation of spacers 160 were to occur. Therefore, defects such as stains generated along a seal line of the first substrate 100 and/or the second substrate 200 may be prevented.

The sealant 163 may be positioned between the first substrate 100 and the second substrate 200 in the non-display area II. The sealant 163 may combine the first substrate 100 with the second substrate 200 and may secure the space for the liquid crystal layer 218 between the first and the second substrates 100 and 200 in conjunction with the spacer 160.

FIG. 2 is a schematic plan view illustrating a liquid crystal display device in accordance with example embodiments.

Referring to FIGS. 1 and 2, the sealant 163 may be located in the non-display area II along the seal line provided at peripheral portions of the first and the second substrates 100 and 200. Here, the non-display area II may surround the display area I. For example, the sealant 163 may have a structure such as a substantially tetragonal ring shape, a substantially circular ring shape, a substantially elliptical ring shape or a substantially polygonal ring shape located between the first and the second substrates 100 and 200. In this case, the spacer 160 may be provided between the display area I and the non-display area II. For example, the spacer 160 may be located between the sealant 163 and the display area I. As described above, the spacer 160 may have a planar structure substantially the same as or substantially similar to that of the recess 145 of the blocking structure. In example embodiments, each of the spacer 160 and the sealant 163 may include a material capable of being hardened by irradiation of ultraviolet (UV) light, laser beam, visible light, etc. For example, each of the sealant 163 and the spacer 160 may include epoxy acrylate-based resin, polyester acrylate-based resin, urethane acrylate-based resin, polybutadine acrylate-based resin, silicon acrylate-based resin, alkyl acrylate-based resin, etc. These may be used alone or in a combination thereof. In some example embodiments, the sealant 163 may include photocurable resin containing carbon, so that the sealant 163 may prevent leakage of light from a light source of the liquid crystal display device toward sides of the first and the second substrates 100 and 200.

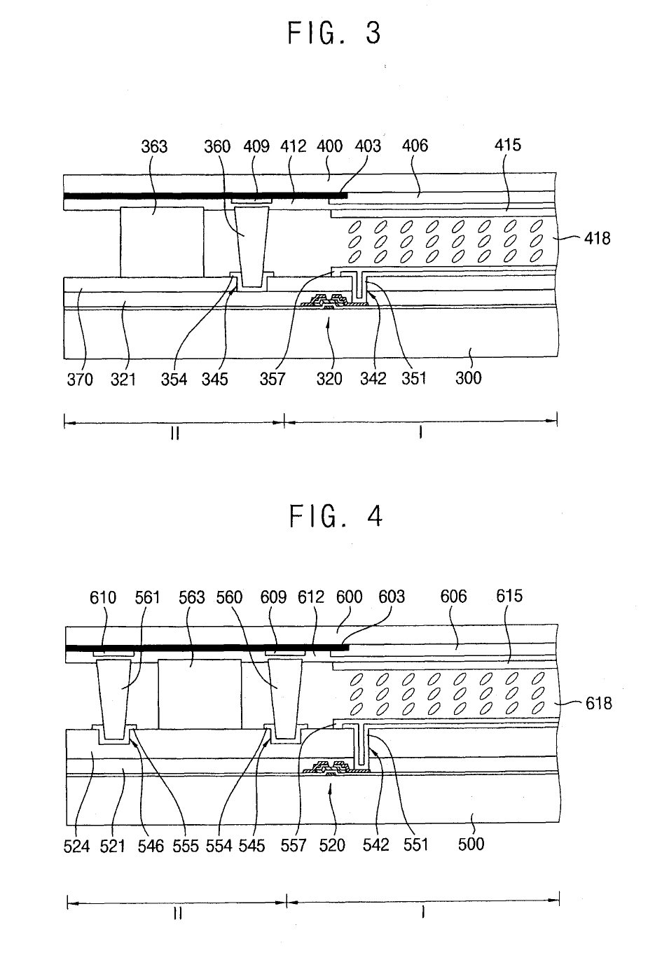

FIG. 3 is a cross-sectional view illustrating a liquid crystal display device in accordance with some example embodiments. The liquid crystal display device illustrated in FIG. 3 may have a construction (e.g., a configuration) that is substantially the same as or substantially similar to that of the liquid crystal display device described with reference to FIG. 1, except for a blocking structure, a protection layer, an insulation layer, etc.

Referring to FIG. 3, a switching device 320 may be provided on a first substrate 300 having a display area I and a non-display area II. In some example embodiments, a buffer layer (not illustrated) may be additionally located between the first substrate 300 and the switching device 320. The buffer layer may include a silicon compound such as silicon oxide, silicon nitride, silicon oxynitride, etc.

In the display area I of the liquid crystal display device, the switching device 320 may include a gate electrode, a gate insulation layer, an active layer, a first ohmic contact pattern, a second ohmic contact pattern, a source electrode, a drain electrode, etc. The switching device 320 may have a construction (e.g., a configuration) that is substantially the same as or substantially similar to that of the switching device 120 described with reference to FIG. 1.

An insulation interlayer 321 may be located on the first substrate 300 to cover the switching device 320. In example embodiments, the insulation interlayer 321 may directly cover the switching device 320 on the first substrate 300. The insulation interlayer 321 may have a substantially level upper face and may extend from the display area I to the non-display area II. The insulation interlayer 321 may include oxide, nitride, oxynitride, an organic insulating material, etc.

A protection layer 370 may be positioned on the insulation interlayer 321. The protection layer 370 may include an organic insulating material or an inorganic material. For example, the protection layer 370 may include acryl-based resin, polyamide-based resin, siloxane-based resin, silicon oxide, silicon nitride, silicon oxynitride, etc. These may be used alone or in a combination thereof. The protection layer 370 may have a substantially level upper face on the interlayer insulation layer 321. The protection layer 370 may also extend from the display area Ito the non-display area II.

A contact hole 342 may be provided through the protection layer 370 and the insulation interlayer 321 located in the display area I. The contact hole 342 may partially expose a drain electrode of the switching device 320. Here, a first electrode 351 may be located on the exposed drain electrode, the contact hole 342 and the protection layer 370. The first electrode 351 may include a transparent conductive material, a reflective material, etc. The first electrode 351 may extend on the protection layer 370 in the display area I.

A first alignment layer 357 may be located on the protection layer 370 to cover the first electrode 351. The first alignment layer 357 may cover an end portion of the first electrode 351 adjacent to the non-display area II. The first alignment layer 357 may extend to a portion of the protection layer 370 under which the switching device 320 is located. In some example embodiments, the first alignment layer 357 may not be located on the first substrate 351 according to an alignment of liquid crystal molecules in a liquid crystal layer 418.

A light blocking layer 403 may be located on a second substrate 400 in the non-display area II and a color filter 406 may be positioned on the second substrate 400 in the display area I. In example embodiments, a first portion of the light blocking layer 403 may be partially overlapped with a first portion of the color filter 406. For example, an end portion of the color filter 406 may cover an end portion of the light blocking layer 403.

A second electrode 412 covering the light blocking layer 403 and the color filter 406 may be located on the second substrate 400 from the display area I to the non-display area II. The second electrode 412 may include a transparent conductive material, a reflective material, etc. In the display area I, a second alignment layer 415 may be located on the second electrode 412. The second alignment layer 415 may be substantially opposed to the first alignment layer 357. Here, the liquid crystal layer 418 may be positioned between the first and the second alignment layers 357 and 415. In some example embodiments, the second alignment layer 415 may not be located on the second electrode 412. In the non-display area II, a compensation member 409 may be located between the second electrode 412 and the light blocking layer 403. The compensation member 409 may include a material substantially the same as or substantially similar to that of the color filter 406, that of the light blocking layer 403, etc. In some example embodiments, the compensation member 409 may include photocurable resin. In this case, the compensation member 409 may include a material that is substantially the same as or substantially similar to that of a spacer 360, that of a sealant 363, etc.

As illustrated in FIG. 3, a blocking structure of the liquid crystal display device may include a recess 345 and a blocking member 354. The recess 345 may be formed through the protection layer 370 adjacent to the display area I. For example, the recess 345 may partially expose the insulation interlayer 321 located beneath the protection layer 370. In example embodiments, a thickness of the protection layer 370 may be substantially the same as or substantially similar to a depth of the recess 345 when the recess 345 passes through the protection layer 370. Thus, the protection layer 370 may not have a sufficient thickness when considering forming of the recess 345 thereon.

The blocking member 354 of the blocking structure may be located on the exposed insulation interlayer 321, a sidewall of the recess 345 and a portion of the protection layer 370. The blocking member 354 may include a material that is substantially the same as or substantially similar to that of the second electrode 412 and/or the first electrode 351. The blocking member 354 may be electrically coupled to the first electrode 351, a data line (not illustrated) and/or a gate line (not illustrated). An electric field may be generated around the spacer 360 between the blocking member 354 and the second electrode 412 when a voltage (e.g., a predetermined voltage) is applied to the blocking member 354 or the second electrode 412.

In the non-display area II of the liquid crystal display device, a lower portion of the spacer 360 may be located on the blocking member 354, and may be received in the recess 345. The sealant 363 adjacent to the spacer 360 may be positioned on the protection layer 370. The sealant 363 may be located along a seal line at peripheral portions of the first and the second substrates 300 and 400. The spacer 360 may have a construction (e.g., a configuration) that is substantially the same as or substantially similar to that of the sealant 363, which may be located between the display area I and the non-display area II.

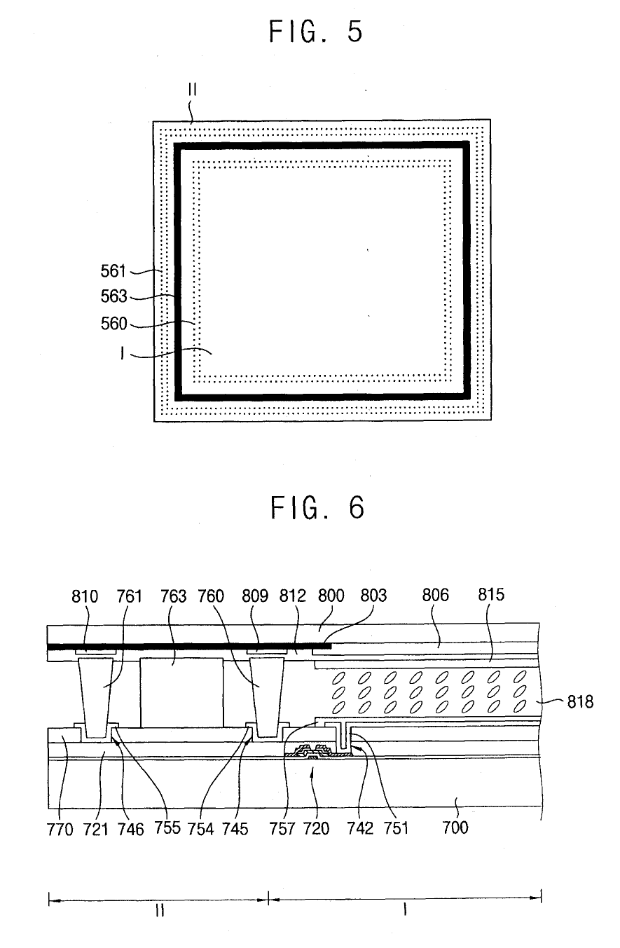

FIG. 4 is a cross-sectional view illustrating a liquid crystal display device in accordance with some example embodiments. FIG. 5 is a schematic plan view illustrating a liquid crystal display device in accordance with some example embodiments. The liquid crystal display device illustrated in FIGS. 4 and 5 may have a construction (e.g., a configuration) that is substantially the same as or substantially similar to that of the liquid crystal display device described with reference to FIGS. 1 and 2, except for a blocking structure, spacers, etc.

As illustrated in FIG. 4, the liquid crystal display device may include a first substrate 500, a switching device 520, a protection layer 521, an insulation layer 524, a first electrode 551, a liquid crystal layer 518, a second electrode 612, a color filter 606, a first spacer 560, a second spacer 561, a sealant 563, a first compensation member 609, a second compensation member 610, a blocking structure, a second substrate 600, etc. Here, the blocking structure may include a first recess 545, a second recess 546, a first blocking member 554 and a second blocking member 555.

Referring to FIG. 4, the switching device 520, the first electrode 551, a first alignment layer 557, the liquid crystal layer 518, a second alignment layer 615 and the color filter 606 may be located in a display area I of the liquid crystal display device. Here, the first electrode 551 may be electrically coupled to a drain electrode of the switching device 520 exposed through a contact hole 542. The blocking member, the first and the second spacers 560 and 561, the first and the second compensation members 609 and 610, the sealant 563 and a light blocking layer 603 may be positioned in a non-display area II of the liquid crystal display device. Further, the protection layer 521, the insulation layer 524 and the second electrode 612 may extend from the display area Ito the non-display area II.

As illustrated in FIGS. 4 and 5, the sealant 563 may be positioned at peripheral portions of the first and the second substrates 500 and 600. The first and the second spacers 560 and 561 may be located adjacent to both end portions of the sealant 563. For example, the first spacer 560 may be positioned adjacent to the display area I and the second spacer 561 may be located adjacent to the sealant 563. Thus, the sealant 563 may be located between the first and the second spacers 560 and 561. In example embodiments, the liquid crystal display device may have a construction (e.g., a configuration) in which the sealant 563 may surround the first spacer 560, and the second spacer 561 may surround the sealant 563.

The first and the second compensation members 609 and 610 may substantially correspond to the first and the second spacers 560 and 561, respectively. For example, the first and the second compensation members 609 and 610 may be positioned on the first and the second spacers 560 and 561, respectively. Here, the second electrode 612 may be located between the first compensation member 609 and the first spacer 560 and between the second compensation member 610 and the second spacer 561. In some example embodiments, at least one of the first compensation member 609 or the second compensation member 610 may not be provided according to structures or sizes of the first and the second spacers 560 and 561.

The first recess 545 and the first blocking member 554 of the blocking structure may be located beneath the first spacer 560. The second recess 546 and the second blocking member 555 of the blocking structure may be located beneath the second spacer 561. Lower portions of the first and the second spacers 560 and 561 may be respectively located on the first and the second blocking members 554 and 555, so that the first and the second spacers 560 and 561 may be partially buried in the first recess 545 and the second recess 546, respectively. Each of the first and the second blocking members 554 and 555 may include a material that is substantially the same as or substantially similar to that of the first electrode 551 and/or that of the second electrode 612. Further, each of the first and the second blocking members 554 and 555 may be electrically coupled to the first electrode 551 or a wiring (not illustrated) such as a gate line or a data line. When a voltage (e.g., a predetermined voltage) is applied to the first and the second blocking members 554 and 555, electric fields may be generated around the first and the second spacers 560 and 561, respectively. The electric field around the sealant 563 may effectively block permeation of external moisture, ionic impurities, etc. Therefore, defects such as stains at the peripheral portions of the first and the second substrates 500 and 600 may be efficiently prevented.

FIG. 6 is a cross-sectional view illustrating a liquid crystal display device in accordance with some example embodiments. The liquid crystal display device illustrated in FIG. 6 may have a construction (e.g., a configuration) that is substantially the same as or substantially similar to that of the liquid crystal display device described with reference to FIG. 3, except for a blocking structure, a spacer, etc.

Referring to FIG. 6, a switching device 720 may be provided on a first substrate 700 in a display area I of the liquid crystal display device. An insulation interlayer 721 covering the switching device 720 may be located on the first substrate 700. The insulation interlayer 721 may extend from the display area I to a non-display area II of the liquid crystal display device.

A protection layer 770 may be positioned on the insulation interlayer 721. A contact hole 742 may be formed through the protection layer 770 and the insulation interlayer 721 in the display area I, such that a drain electrode of the switching device 720 may be partially exposed by the contact hole 742. A first electrode 751 may be located on the exposed drain electrode and a sidewall of the contact hole 742. The first electrode 751 may extend on the protection layer 770. A first alignment layer 770 covering the first electrode 751 may be located on the protection layer 770 in the display area I. In some example embodiments, the first alignment layer 770 may be omitted.

A blocking structure may be located in the non-display area II of the liquid crystal display device. The blocking structure may include a first recess 745, a second recess 746, a first blocking member 754 and a second blocking member 755. The first recess 745 may pass through a first portion of the protection layer 770 to expose a first portion of the insulation interlayer 721. The first blocking member 754 may be located on the exposed first portion of the insulation interlayer 721 and a sidewall of the first recess 745. In this case, the first blocking member 754 may partially extend on the protection layer 770. The second recess 746 may be formed through a second portion of the protection layer 770 to expose a second portion of the insulation interlayer 721. A sealant 763 may be positioned on the protection layer 770 between the first and the second recesses 745 and 746. The second blocking member 755 may be located on the exposed second portion of the insulation interlayer 721. The second blocking member 755 may also partially extend on the protection layer 770.

In example embodiments, a first spacer 760 and a second spacer 761 may be located substantially centering the sealant 763. In other words, the first spacer 760 and the second spacer 761 may be arranged to be substantially equidistance to the sealant 763. A lower portion of the first spacer 760 may be located on the first blocking member 754, so that the lower portion of the first spacer 760 may be partially received in the first recess 745. A lower portion of the second spacer 761 may be located on the second blocking member 755, such that the lower portion of the second spacer 761 may be partially buried in the second recess 746. Here, the first and the second spacers 760 and 761 and the sealant 763 may have constructions (e.g., configurations) that are substantially the same as or substantially similar to those of the first and the second spacers 560 and 561 and the sealant 563 described with reference to FIGS. 4 and 5. The first and the second blocking members 754 and 755 may be electrically coupled to the first electrode 751, a gate line and/or a data line, so that electric fields may be generated around the first and the second spacers 760 and 761 to thereby prevent permeation of moisture, impurities, etc.

A light blocking layer 803 may be located on the non-display area II. The light blocking layer 803 may extend over the switching device 720 located in the display area I. A first compensation member 809 and a second compensation member 810 may be positioned on the light blocking layer 803. The first and the second compensation members 809 and 810 may substantially correspond to the first and the second spacers 760 and 761, respectively. The first and the second compensation members 809 and 810 may be spaced apart from the first and the second spacers 760 and 761 with a second electrode 812 interposed therebetween. A color filter 805 may be located on the second substrate 800 in the display area I. When the light blocking layer 803 extends to a portion of the display area I, the color filter 806 may be substantially overlapped with an extended portion of the light blocking layer 803.

The second electrode 812 may extend from the display area Ito the non-display area II. The second electrode 812 may cover the color filter 806, the light blocking layer 803, the first compensation member 809 and the second compensation member 810. A second alignment layer 815 may be located on the second electrode 812 in the display area I. The second alignment layer 815 may be substantially opposed to the first alignment layer 757. The second alignment layer 815 may be omitted as occasion demands. A liquid crystal layer 818 may be located between the first and the second alignment layers 757 and 815 in the display area I. In some example embodiments, when the first alignment layer 757 and/or the second alignment layer 815 are not provided, the liquid crystal layer 818 may be positioned between the first electrode 751 and the second electrode 812. For example, when the liquid crystal display device does not include the first and the second alignment layers 757 and 815, the liquid crystal layer 818 may make contact with the first and the second electrodes 751 and 812.

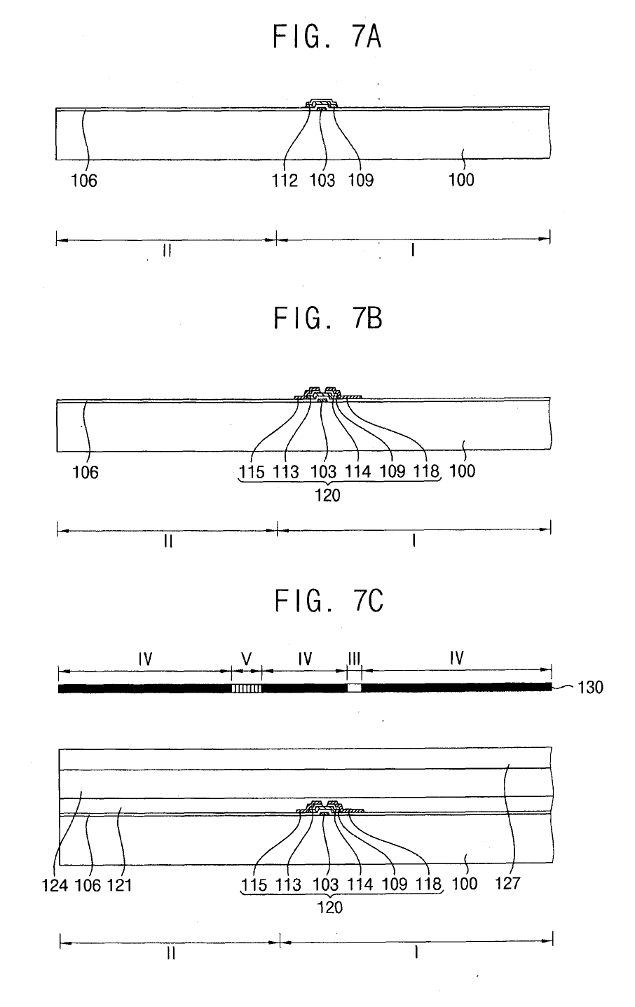

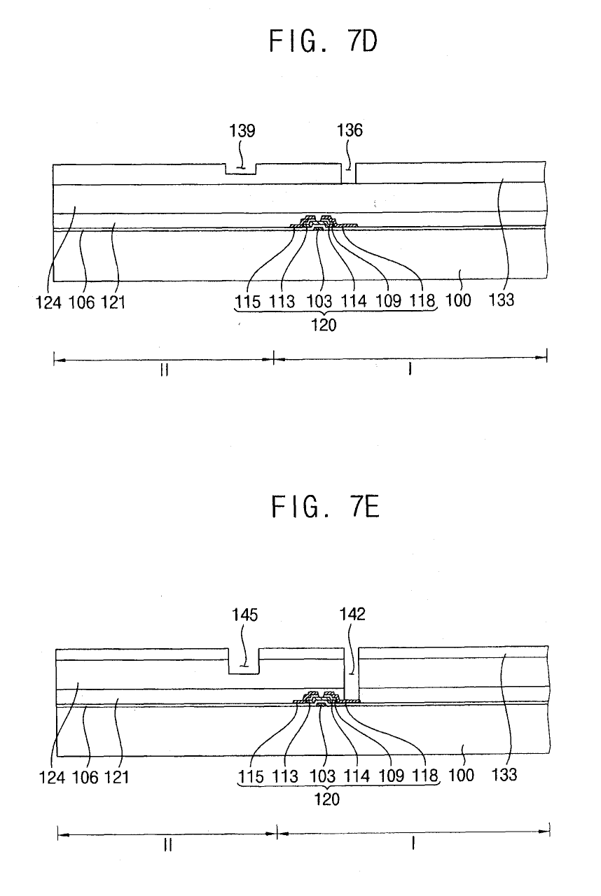

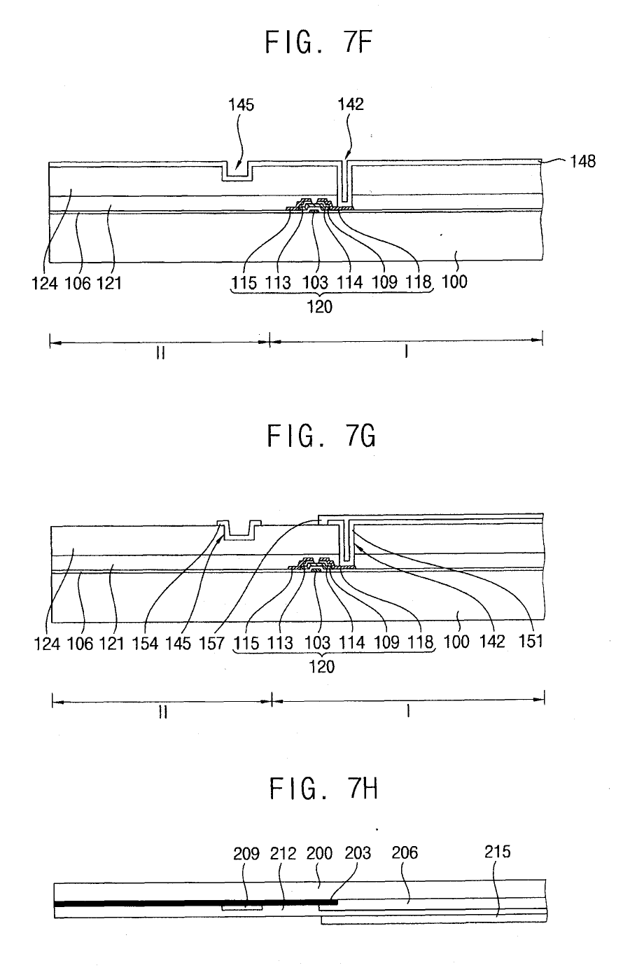

FIGS. 7A to 7H are cross-sectional views illustrating a method of manufacturing a liquid crystal display device in accordance with example embodiments. The liquid crystal display device manufactured by the method illustrated in FIGS. 7A to 7H may have a construction (e.g., a configuration) that is substantially the same as or substantially similar to that of the liquid crystal display device described with reference to FIG. 1. However, a liquid crystal display device having a construction (e.g., a configuration) that is substantially the same as or substantially similar to that of the liquid crystal display device with reference to FIG. 3, 4 or 6, may be manufactured by modifying some processes such as a process for forming a blocking structure, a process for forming a spacer, etc., as those skilled in the art would appreciate.

Referring to FIG. 7A, a gate electrode 103 may be formed on a first substrate 100 in a display area I of the liquid crystal display device. The first substrate 100 may include a transparent insulation substrate. For example, the first substrate 100 may include a glass substrate, a quartz substrate, a transparent plastic substrate, a transparent metal oxide substrate, etc. The gate electrode 103 may be obtained using metal, alloy and/or metal nitride by a sputtering process, a chemical vapor deposition (CVD) process, an atomic layer deposition (ALD) process, a vacuum evaporation process, a printing process, etc.

In forming of the gate electrode 103 according to example embodiments, a first conductive layer (not illustrated) may be formed on the first substrate 100 using a metal, an alloy and/or a metal nitride, and then the gate electrode 103 may be formed in the display area I by patterning the first conductive layer. In this case, a gate line (not illustrate) for applying a voltage to the gate electrode 103, may be formed on the first substrate 100.

A gate insulation layer 106 may be formed on the first substrate 100 to cover the gate electrode 103. The gate insulation layer 106 may be formed in the display area I and a non-display area II of the liquid crystal display device. The gate insulation layer 106 may be conformaly formed on the first substrate 100 along a profile of the gate electrode 103 and/or the gate line. The gate insulation layer 106 may be formed using oxide, nitride, oxynitride, an organic insulating material, etc. Further, the gate insulation layer 106 may be obtained by a sputtering process, a spin coating process, a chemical vapor deposition process, a plasma enhanced chemical vapor deposition (PECVD) process, a high density plasma-chemical vapor deposition (HDP-CVD) process, a vacuum evaporation process, a printing process, etc.

An active layer 109 and an ohmic contact layer 112 may be formed on a portion of the gate insulation layer 106 under which the gate electrode 103 is located. The active layer 106 and the ohmic contact layer 112 may be formed over the first substrate 100 in the display area I. The active layer 109 may have an area substantially larger than that of the gate electrode 103. When the gate insulation layer 106 has a stepped portion caused by the gate electrode 103, the active layer 109 may also have a stepped portion that is substantially the same as or substantially similar to the stepped portion of the gate insulation layer 106. The active layer 109 may be formed using silicon by a sputtering process, a spin coating process, a chemical vapor deposition process, a plasma enhanced chemical vapor deposition process, a high density plasma-chemical vapor deposition process, a vacuum evaporation process, etc.

The ohmic contact layer 112 may have an area that is substantially smaller than that of the active layer 109. The ohmic contact layer 112 may have a stepped portion caused by the gate insulation layer 106 covering the gate electrode 103. The ohmic contact layer 112 may be formed using silicon, metal oxide, etc. Further, the ohmic contact layer 112 may be formed by a sputtering process, a spin coating process, a chemical vapor deposition process, a plasma enhanced chemical vapor deposition process, a high density plasma-chemical vapor deposition process, a vacuum evaporation process, etc.

Referring to FIG. 7B, after forming a second conductive layer (not illustrated) on the gate insulation layer 106 to cover the ohmic contact layer 112, the second conductive layer and the ohmic contact layer 112 may be partially etched. Thus, a first ohmic contact pattern 113 and a second ohmic contact pattern 114 may be formed on the active layer 109. Additionally, a source electrode 115 and a drain electrode 118 may be formed on the first ohmic contact pattern 113 and the second ohmic contact pattern 114, respectively. The second conductive layer may be formed using metal, alloy, metal nitride, etc. These may be used alone or in a combination thereof. Further, the second conductive layer may be formed by a sputtering process, a chemical vapor deposition process, an atomic layer deposition process, a vacuum evaporation process, a printing process, etc. As the source and the drain electrodes 115 and 118 are formed, a switching device 120, such as, for example, a thin film transistor, may be provided on the first substrate 100. In example embodiments, the source electrode 115, the drain electrode 118, the first ohmic contact pattern 113 and the second ohmic contact pattern 114 may be obtained by performing an etching process once. Further, a data line (not illustrated) electrically coupled to the source electrode 115 may be formed on the gate insulation layer 106 while forming the source electrode 115 and the drain electrode 118. Here, the data line may extend on the gate insulation layer 106 in a direction substantially perpendicular to a direction where the gate line extends.

Referring to FIG. 7C, a protection layer 121 may be formed on the first substrate 100 to cover the switching device 120. The protection layer 121 may have a sufficient thickness to completely cover the switching device 120. The protection layer 121 may be formed using oxide, nitride, oxynitride, an organic insulating material, etc. Further, the protection layer 121 may be formed by a sputtering process, a spin coating process, a chemical vapor deposition process, a plasma enhanced chemical vapor deposition process, a high density-plasma chemical vapor deposition process, a vacuum evaporation process, a printing process, etc. In example embodiments, an upper face of the protection layer 121 may be planarized by performing a planarization process about the protection layer 121. For example, the protection layer 121 may be planarized by a chemical mechanical polishing (CMP) process, an etch-back process, etc. Hence, the protection layer 121 may have a substantially flat upper face.

After forming an insulation layer 124 on the protection layer 121, a photoresist film 127 may be formed on the insulation layer 124. For example, the insulation layer 124 may be formed using an organic insulating material such as benzocyclobutene-based resin, olefin-based resin, polyamide-based resin, acryl-based resin, polyvinyl-based resin, etc. These may be used alone or in a combination thereof. The insulation layer 124 may be obtained by a spin coating process, a printing process, a vacuum evaporation process, etc.

As illustrated in FIG. 7C, a mask 130 may be placed on the photoresist film 127. The mask 130 may include a half tone mask or a half tone slit mask, which has regions of different transmittances of light.

In example embodiments, the mask 130 may include a transparent region III, a light blocking region IV and a transflective region V. In forming of the mask 130 on the photoresist film 127, the transparent region III of the mask 130 may be located on a first portion of the photoresist film 127 under which the drain electrode 118 is located, and the transflective region V of the mask 130 may be located on a second portion of the photoresist film 127 on which a spacer (not illustrated) will be formed. For example, the transflective region V of the mask 130 may be located in the non-display area II adjacent to the display area I.

Referring to FIG. 7D, a photoresist pattern 133 may be formed on the insulation layer 124 by performing an exposure process and a developing process about the photoresist film 127 using the mask 130. Because the photoresist pattern 133 is formed using the mask 130 having the above-described structure, the photoresist pattern 133 may have an opening 136 and a groove 139. For example, the opening 136 and the groove 139 of the photoresist pattern 133 may have different depths, respectively using the half tone mask, the half tone slit mask, etc. In this case, the opening 136 of the photoresist pattern 133 may be formed to expose a first portion of the insulation layer 124 under which the drain electrode 118 is located. Further, the groove 139 of the photoresist pattern 133 may be formed on a second portion of the insulation layer 124 on which a recess 145 (see FIG. 7E) will be formed. Therefore, the first portion of the insulation layer 124 may be exposed by the opening 136 whereas the second portion of the insulation layer 124 may not be exposed by the groove 139. The groove 139 of the photoresist pattern 133 may have a width substantially larger than that of a lower portion of the spacer that will be formed thereon.

Referring to FIG. 7E, a contact hole 142 and a recess 145 may be formed by etching the first and the second portions of the insulation layer 124 and a portion of the protection layer 121 using the photoresist pattern 133 as an etching mask. The contact hole 142 may be formed through the first portion of the insulation layer 124 and the protection layer 121 to expose the drain electrode 118. The recess 145 may be formed on the second portion of the insulation layer 124 (e.g., formed to have a predetermined depth). The contact hole 142 and the recess 145 may substantially correspond to the opening 136 and the groove 139, respectively. For example, the contact hole 142 and the recess 145 may have widths that are substantially the same as or substantially similar to those of the opening 136 and the groove 139, respectively. Further, the contact hole 142 and the recess 145 may communicate with the opening 136 and the groove 139, respectively. In the etching process for forming the contact hole 142 and the recess 145, the photoresist pattern 133 may be consumed, so that the photoresist pattern 133 may have a reduced thickness. In some example embodiments, at least one recess may be formed on the insulation layer 124 in the non-display area II by processes that are substantially similar to the processes described with reference to FIGS. 7D and 7E. For example, a first recess and a second recess may be formed on the insulation layer 124 in the non-display area II by modifying the transflective region V of the mask 130.

Referring to FIG. 7F, the photoresist pattern 133 may be removed from the insulation layer 124. For example, the photoresist pattern 133 may be removed by an ashing process and/or a stripping process.

A third conductive layer 148 may be formed on the insulation layer 124 and the drain electrode 118 exposed by the contact hole 142. The third conductive layer 148 may be conformaly formed along profiles of the recess 145 and the contact hole 142. The third conductive layer 148 may extend on the insulation layer 124 formed in the display area I. For example, the third conductive layer 148 may have a uniform thickness on a sidewall and a bottom face of the contact hole 142 and a sidewall and a bottom face of the recess 145. The third conductive layer 48 may be formed using a reflective material, a transparent conductive material, etc. Additionally, the third conductive layer 148 may be formed by a sputtering process, a chemical vapor deposition process, an atomic layer deposition process, a vacuum evaporation process, a printing process, etc.

Referring to FIG. 7G, a first electrode 151 and a blocking member 154 may be formed on the insulation layer 124 by patterning the third conductive layer 148. The first electrode 151 may be formed on the drain electrode 118, the sidewall of the contact hole 142 and the insulation layer 124 in the display area I. The blocking member 154 may be formed on the sidewall and the bottom face of the recess 145 of the insulation layer 124 in the non-display area II. In example embodiments, both of end portions of the blocking member 154 may extend on the insulation layer 124 adjacent to the recess 145. Further, the blocking member 154 may be electrically coupled to the first electrode 151. In some example embodiments, when a plurality of recesses are formed on the insulation layer 124, a plurality of blocking members may be formed in the recesses by partially modifying the process of patterning the third conductive layer 148.

A first alignment layer 157 may be formed on the first electrode 151 in the display area I of the liquid crystal display device. The first alignment layer 157 may be formed using polyimide-based resin, carbon nanotubes, polyamide-based resin, etc. These may be used alone or in a combination thereof. In example embodiments, a rubbing process may be performed about the first alignment layer 157 for aligning liquid crystal molecules in a liquid crystal layer (not illustrated) in a predetermined direction.

Referring to FIG. 7H, a second substrate 200 substantially opposed to the first substrate 100 may be provided. The second substrate 200 may include a transparent insulation substrate. For example, the second substrate 200 may include a glass substrate, a quartz substrate, a transparent plastic substrate, a transparent metal oxide substrate, etc. In example embodiments, the second substrate 200 may have a material substantially the same as that of the first substrate 100. Alternatively, the first and the second substrates 100 and 200 may have different materials, respectively. Substantially similar to the first substrate 100, the second substrate 200 may have the display area I and the non-display area II.

A light blocking layer 203 may be formed on the second substrate 200. The light blocking layer 203 may be positioned on the non-display area II of the second substrate 200 and may be extended to a portion of the display area I. For example, the light blocking layer 203 may be extended on the switching device 120 located in the display area I. The light blocking layer 203 may be formed using metal, alloy, metal oxide, etc. For example, the light blocking layer 203 may be formed using chrome, aluminum, titanium, an alloy of these metals, chrome oxide, aluminum oxide, titanium oxide, etc. The light blocking layer 203 may be formed by a sputtering process, a chemical vapor deposition process, an atomic layer deposition process, a vacuum evaporation process, a printing process, etc.

A color filter 206 may be formed in the display area I of the second substrate 200. The color filter 206 may be partially overlapped with an extended portion of the light blocking layer 203 in the display area I. In example embodiments, a plurality of color filters 206 for filtering red color of light, green color of light and blue color of light may be formed in the display area I of the liquid crystal display device.

As illustrated in FIG. 7H, a compensation member 209 may be formed on the light blocking layer 203 under which a spacer (not illustrated) will be formed. In example embodiments, the blocking member 209 may be formed using a material that is substantially the same as or substantially similar to that of the light blocking layer 203. In this case, the light blocking layer 203 and the compensation member 209 may be substantially integrally formed. For example, the compensation member 209 may be formed on the light blocking layer 203 while forming the light blocking layer 203 using a half tone mask, a half tone slit mask, etc. In some example embodiments, the compensation member 203 may be formed using a material that is substantially the same as or substantially similar to that of the spacer. Here, the compensation member 203 may be hardened (e.g., hardened in a predetermined shape) for supporting the spacer by a successive hardening process.

A second electrode 212 may be formed in the display area I and the non-display area II of the second substrate 200. The second electrode 212 may cover the color filter 206 and a portion of the light blocking layer 203 in the display area I. Additionally, the second electrode 212 may cover the compensation member 209 and the light blocking layer 203 in the non-display area II. The second electrode 212 may be formed using a transparent conductive material, a reflective material, etc. The second electrode 212 may be formed by a sputtering process, a chemical vapor deposition process, an atomic layer deposition process, a vacuum evaporation process, a printing process, etc. In example embodiments, the second electrode 212 may extend to the non-display area II in which the spacer is located, so that an electric field may be generated around the spacer positioned between the second electrode 212 and the blocking member 154 when a voltage (e.g., a predetermined voltage) is applied to the blocking member 154.

Referring now to FIG. 7H, a second alignment layer 215 may be formed on the second substrate 212 in the display area I. The second alignment layer 215 may be formed using polyimide-based resin, carbon nanotubes, polyamide-based resin, etc. These may be used alone or in a combination thereof. In example embodiments, a rubbing process may be performed about the second alignment layer 215 for adjusting an initial alignment of liquid crystal molecules in the liquid crystal layer.

After forming at least one spacer (not illustrated) and a sealant (not illustrated) between the first substrate 100 described with reference to FIG. 7G and the second substrate 200 described with reference to FIG. 7H, the liquid crystal layer may be formed between the first and the second substrates 100 and 200 in the display area I. Here, the liquid crystal layer may be formed in a space provided by the spacer between the first and the second substrates 100 and 200. For example, the liquid crystal layer may be formed between the first electrode 151 and the second electrode 212 in the display area I. The liquid crystal display device having a construction (e.g., a configuration) that is substantially the same as that of the liquid crystal display device described with reference to FIG. 1, may be manufactured by performing the hardening process about the spacer and the sealant. In this case, the spacer may be received in the recess 145 having the blocking member 154 therein. The sealant may be formed in the non-display area II adjacent to the spacer. In example embodiments, the spacer and the sealant may be formed using photocurable resin. The spacer and the sealant may include substantially the same resin or may include different resins.

Although it is not illustrated, a liquid crystal display device having a construction (e.g., a configuration) that is substantially the same as or substantially similar to that of liquid crystal display device described with reference to FIG. 3, 4 or 6, may be manufactured by partially modifying manufacturing processes such as a process of forming at least one recess by etching the insulation layer 124, a process of forming at least one blocking member in the at least one recess by patterning the third conductive layer 148, a process of forming at least one spacer and at least one compensation member in the non-display area II, etc.

According to example embodiments, a liquid crystal display device may include at least one blocking structure partially enclosing at least one spacer, so that deterioration of a liquid crystal layer by permeation of moistures and/or impurities may be prevented while using the liquid crystal display device. Further, defects such as stains generated at a peripheral portion of the liquid crystal display device may be effectively prevented by the blocking structure even if the process for manufacturing the liquid crystal display device were carried out under processing conditions of high temperature and humidity.

The foregoing is illustrative of example embodiments and is not to be construed as limiting thereof. Although a few example embodiments have been described, those skilled in the art will readily appreciate that many modifications are possible in the example embodiments without materially departing from the novel teachings and aspects of example embodiments. Accordingly, all such modifications are intended to be included within the scope of the invention as defined in the claims and their equivalents. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A liquid crystal display device comprising:
a first substrate having a display area and a non-display area;
a first electrode on the first substrate at the display area;
a second substrate opposed to the first substrate;
a second electrode on the second substrate at the display area;
a liquid crystal layer between the first electrode and the second electrode;
a spacer between the first substrate and the second substrate at the non-display area;
a sealant adjacent to the spacer; and
a blocking structure beneath the spacer.

2. The liquid crystal display device of claim 1, further comprising:
a protection layer on the first substrate; and
an insulation layer on the protection layer.

3. The liquid crystal display device of claim 2, wherein the blocking structure comprises a recess formed on the insulation layer and a blocking member located in the recess.

4. The liquid crystal display device of claim 3, wherein the blocking member is located on a bottom face of the recess, a sidewall of the recess and the insulation layer.

5. The liquid crystal display device of claim 3, wherein the spacer is partially buried in the recess.

6. The liquid crystal display device of claim 3, wherein the blocking member comprises a material that is substantially the same as that of the first electrode or the second electrode.

7. The liquid crystal display device of claim 3, wherein the blocking member is electrically coupled to the first electrode.

8. The liquid crystal display device of claim 7, wherein the blocking member is configured to generate an electric field around the spacer when a voltage is applied to the blocking member.

9. The liquid crystal display device of claim 3, further comprising a compensation member located on the spacer.

10. The liquid crystal display device of claim 2, wherein the spacer comprises a first spacer and a second spacer that are located between the first substrate and the second substrate at the non-display area,
wherein the sealant is located between the first spacer and the second spacer.

11. The liquid crystal display device of claim 10, wherein the blocking structure comprises:
a first recess on the insulation layer under the first spacer;
a first blocking member located in the first recess;
a second recess on the insulation layer under the second spacer; and
a second blocking member located in the second recess.

12. The liquid crystal display device of claim 11, wherein each of the first blocking member and the second blocking member is electrically coupled to the first electrode.

13. The liquid crystal display device of claim 11, wherein the first spacer and the second spacer are partially buried in the first recess and the second recess, respectively.

14. The liquid crystal display device of claim 11, further comprising a first compensation member located on the first spacer and a second compensation member located on the second spacer.

15. The liquid crystal display device of claim 1, further comprising:
an insulation layer located on the first substrate; and
a protection layer located on the insulation layer.

16. The liquid crystal display device of claim 15, wherein the blocking structure includes:
a recess penetrating the protection layer to partially expose the insulation layer; and
a blocking member located on the insulation layer, a sidewall of the recess and the protection layer.

17. The liquid crystal display device of claim 15, wherein the blocking structure comprises:
a first recess and a second recess formed through the protection layer to partially expose the insulation layer;
a first blocking member located in the first recess; and
a second blocking member located in the second recess.

18. The liquid crystal display device of claim 17, wherein the spacer comprises a first spacer partially buried in the first recess and a second spacer partially buried in the second recess,
wherein the sealant is located between the first spacer and the second spacer.

19. A method of manufacturing a liquid crystal display device, the method comprising:
forming a switching device at a display area of a first substrate;
forming a blocking structure at a non-display area of the first substrate;
forming a first electrode on the first substrate at the display area;
forming a second electrode on a second substrate opposed to the first substrate;
forming a liquid crystal layer between the first electrode and the second electrode;
forming a spacer between the first substrate and the second substrate at the non-display area; and
forming a sealant adjacent to the spacer.

20. The method of claim 19, wherein forming the blocking structure comprises:
forming an insulation layer on the first substrate;
forming a recess on the insulation layer at the non-display area; and
forming a blocking member in recess.

21. The method of claim 20, further comprising forming a protection layer on the first substrate to cover the switching device before forming the insulation layer.

22. The method of claim 20, wherein forming the recess further comprises forming a contact hole through the insulation layer at the display area to partially expose the switching device.

23. The method of claim 22, wherein forming the recess is performed using a mask having a blocking region, a transparent region and a transflective region.

24. The method of claim 22, wherein forming the blocking member further comprises:
forming a conductive layer on a bottom face and a sidewall of the recess, on a bottom face and a sidewall of the contact hole and on the insulation layer; and
forming the blocking member and the first electrode by patterning the conductive layer.

25. The method of claim 19, further comprising forming a compensation member corresponding to the spacer on the second substrate before forming the second electrode.
